(19) United States
(12) Patent Application Publication
(10) Pub. No.: US 2025/0071597 A1
(43) Pub. Date: Feb. 27, 2025

(54) RESOURCE ALLOCATION INDICATION IN UNRESTRICTED BANDWIDTH PART

(71) Applicant: QUALCOMM Incorporated, San Diego, CA (US)

(72) Inventors: Jing LEI, San Diego, CA (US); Kazuki TAKEDA, Minato-ku (JP); Peter GAAL, San Diego, CA (US)

(21) Appl. No.: 18/790,990

(22) Filed: Jul. 31, 2024

Related U.S. Application Data
(60) Provisional application No. 63/578,942, filed on Aug. 25, 2023.

(51) Int. Cl. H04W 28/02; H04L 5/00; H04W 72/0453; H04W 72/1273

(52) U.S. Cl. CPC H04W 28/0215; H04L 5/0048; H04W 72/0453; H04W 72/1273

(57) ABSTRACT

Methods, systems, and devices for wireless communication are described. A user equipment (UE) may determine resource allocation information when operating on an unrestricted bandwidth part (BWP) that is not configured with a control resource set (CORESET) associated with system information (SI) acquisition. For example, the UE may receive first control information indicating a first CORESET associated with SI acquisition. The UE may receive second control information indicating an unrestricted BWP that is configured with a second CORESET that is different than the first CORESET. The unrestricted BWP may have a bandwidth that is equal to, greater than, or less than the bandwidth of the first CORESET. The UE may determine a resource indicator value (RIV) to include in a frequency domain resource allocation (FDRA) field for the unrestricted BWP. The UE may communicate, via the unrestricted BWP, based on the RIV.

### CROSS REFERENCE

The present Application for Patent claims the benefit of U.S. Provisional Patent Application No. 63/578,942 by LEI et al., entitled “RESOURCE ALLOCATION INDICATION IN UNRESTRICTED BANDWIDTH PART,” filed Aug. 25, 2023, assigned to the assignee hereof, and expressly incorporated by reference herein.

### FIELD OF TECHNOLOGY

The following relates to wireless communication, including resource allocation indication in unrestricted bandwidth part (BWP).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). The UE may be configured to monitor for control messages that may be received in a control resource set (CORESET). A default CORESET (CORESET #0) is generally monitored for reception of control messages that relate to common system information (SI), such as may be included in a default system information block (SIB1). However, the UE may operate in a bandwidth part (BWP) that is not configured with CORESET #0.

### SUMMARY

The described techniques relate to improved methods, systems, devices, and apparatuses that support resource allocation indication in a bandwidth part (BWP) that is not configured with a default control resource set (CORESET) #0. Such a BWP is also referred to as an unrestricted BWP. The techniques described herein may provide for a user equipment (UE) to determine resource allocation information when operating on an unrestricted BWP. For instance, a network entity may configure (e.g., through control information) a UE with a first CORESET associated with system information (SI) acquisition (e.g., a CORESET #0). The network entity may also configure a UE with a BWP (e.g., an unrestricted BWP) that is configured with a second CORESET (e.g., the unrestricted BWP is not configured with the CORESET #0). The bandwidth of the first CORESET may be different than the bandwidth of the unrestricted BWP. The UE may determine a resource indicator value (RIV) to include in a frequency domain resource allocation (FDRA) field for the unrestricted BWP based on the unrestricted BWP being configured with a CORESET other than CORESET #0. The UE and the network entity may communicate via the unrestricted BWP based on the determined RIV.

A method for wireless communication by a UE is described. The method may include receiving first control information indicating a first CORESET associated with system information acquisition, the first CORESET having a first bandwidth, receiving second control information indicating a first BWP that is configured with a second CORESET that is different than the first CORESET, where the first BWP has a second bandwidth, determining a resource indicator value to include in a frequency domain resource allocation field for the first BWP based at least in part on the first BWP being configured with a CORESET that is different from the first CORESET, and communicating, via the first BWP, based on the resource indicator value.

A UE for wireless communication is described. The UE may include one or more memories storing processor executable code, and one or more processors coupled with the one or more memories. The one or more processors may individually or collectively operable to execute the code to cause the UE to receive first control information indicating a first CORESET associated with system information acquisition, the first CORESET having a first bandwidth, receive second control information indicating a first BWP that is configured with a second CORESET that is different than the first CORESET, where the first BWP has a second bandwidth, determine a resource indicator value to include in a frequency domain resource allocation field for the first BWP based at least in part on the first BWP being configured with a CORESET that is different from the first CORESET, and communicating, via the first BWP, based at least in part on the resource indicator value.

Another UE for wireless communication is described. The UE may include means for receiving first control information indicating a first CORESET associated with system information acquisition, the first CORESET having a first bandwidth, means for receiving second control information indicating a first BWP that is configured with a second CORESET that is different than the first CORESET, where the first BWP has a second bandwidth, means for determining a resource indicator value to include in a frequency domain resource allocation field for the first BWP based at least in part on the first BWP being configured with a CORESET that is different from the first CORESET, and means for communicating, via the first BWP, based on the resource indicator value.

A non-transitory computer-readable medium storing code for wireless communication is described. The code may include instructions executable by a processor to receive first control information indicating a first CORESET associated with system information acquisition, the first CORESET having a first bandwidth, receive second control information indicating a first BWP that is configured with a second CORESET that is different than the first CORESET, where the first BWP has a second bandwidth, determine a resource indicator value to include in a frequency domain resource allocation field for the first BWP based at least in part on the first BWP being configured with a CORESET that is different from the first CORESET, and communicating, via the first BWP, based at least in part on the resource indicator value.

Some examples of the method, UEs, and non-transitory computer-readable medium described herein may further include operations, features, means, or instructions for receiving third control information scheduling a physical downlink shared channel associated with a third bandwidth and a first resource block, where the third bandwidth lies within the second bandwidth, and where the first resource block may be a lowest resource block index of the physical downlink shared channel and a value for the first resource block may be greater than or equal to a lowest resource block index of the first BWP. In some examples of the method, UEs, and non-transitory computer-readable medium described herein, the first bandwidth may be larger than the second bandwidth.

In some examples of the method, UEs, and non-transitory computer-readable medium described herein, determining the resource indicator value may include operations, features, means, or instructions for determining a virtual bandwidth and the third bandwidth of the physical downlink shared channel, where the virtual bandwidth may be equal to the first bandwidth, and a highest resource block index of the physical downlink shared channel may be equal to or less than a minimum of a highest resource block index of the first BWP or a difference between the virtual bandwidth and the value for the first resource block, where the resource indicator value may be determined using the virtual bandwidth, the value of the first resource block, and the third bandwidth.

In some examples of the method, UEs, and non-transitory computer-readable medium described herein, determining the resource indicator value may include operations, features, means, or instructions for determining a virtual bandwidth and the third bandwidth of the physical downlink shared channel, where the virtual bandwidth may be equal to the second bandwidth, and a highest resource block index of the physical downlink shared channel may be equal to or less than a difference between the virtual bandwidth and the value for the first resource block, and where the resource indicator value may be determined using the virtual bandwidth, the value of the first resource block, and the third bandwidth.

In some examples of the method, UEs, and non-transitory computer-readable medium described herein, determining the resource indicator value may include operations, features, means, or instructions for calculating a first bit width based on a quantity (e.g., a number) of resource blocks of the first CORESET, where a second bit width may be a bit width of the resource indicator value and including the resource indicator value in the frequency domain resource allocation field if the second bit width may be equal to the first bit width, or including the resource indicator value and a padding of bits in the frequency domain resource allocation field if the second bit width may be less than the first bit width, where the padding of bits may be equal to a difference between the first bit width and the second bit width.

In some examples of the method, UEs, and non-transitory computer-readable medium described herein, the second bandwidth may be larger than the first bandwidth. In some examples of the method, UEs, and non-transitory computer-readable medium described herein, determining the resource indicator value may include operations, features, means, or instructions for determining a virtual bandwidth and the third bandwidth of the physical downlink shared channel, where the virtual bandwidth may be equal to the first bandwidth, and a highest resource block index of the physical downlink shared channel may be equal to or less than a difference between the virtual bandwidth and the value for the first resource block, and where the resource indicator value may be determined using the virtual bandwidth, the value of the first resource block, and the third bandwidth.

In some examples of the method, UEs, and non-transitory computer-readable medium described herein, determining the resource indicator value may include operations, features, means, or instructions for determining a virtual bandwidth and the third bandwidth of the physical downlink shared channel, where the virtual bandwidth may be equal to the second bandwidth, and a highest resource block index of the physical downlink shared channel may be equal to or less than a difference between the virtual bandwidth and the value for the first resource block, and where the resource indicator value may be determined using the virtual bandwidth, the value of the first resource block, and the third bandwidth.

In some examples of the method, UEs, and non-transitory computer-readable medium described herein, determining the resource indicator value may include operations, features, means, or instructions for calculating a first bit width based on the first CORESET, where a second bit width may be a bit width of the resource indicator value and including the resource indicator value in the frequency domain resource allocation field if the second bit width may be equal to the first bit width, or including the resource indicator value and a truncated resource indicator value in the frequency domain resource allocation field if the second bit width may be greater than the first bit width, where the truncated resource indicator value may be equal to a difference between the second bit width and the first bit width.

In some examples of the method, UEs, and non-transitory computer-readable medium described herein, determining the resource indicator value may include operations, features, means, or instructions for determining a virtual bandwidth and the third bandwidth of the physical downlink shared channel, where the virtual bandwidth may be equal to the second bandwidth, and a highest resource block index of the physical downlink shared channel may be equal to or less than a difference between the virtual bandwidth and the value for the first resource block, and where the resource indicator value may be determined using the virtual bandwidth, a size of the first BWP, the value of the first resource block, and the third bandwidth.

In some examples of the method, UEs, and non-transitory computer-readable medium described herein, determining the resource indicator value may include operations, features, means, or instructions for determining a size of a resource block group based on the second bandwidth and a baseline bandwidth, where the baseline bandwidth may be equal to the first bandwidth or a fourth bandwidth associated with a second BWP, and where the resource indicator value may be determined using at least the size of the resource block group.

In some examples of the method, UEs, and non-transitory computer-readable medium described herein, the first CORESET may have a CORESET identification of zero. In some examples of the method, UEs, and non-transitory computer-readable medium described herein, receiving the second control information indicating the first BWP may include operations, features, means, or instructions for receiving the second control information over a radio resource control message or a system information message, where the first BWP may be an unrestricted downlink BWP that may be not associated with the first CORESET.

In some examples of the method, UEs, and non-transitory computer-readable medium described herein, the unrestricted downlink BWP may be a dedicated downlink BWP configured by the radio resource control message for an enhanced mobile broadband (eMBB) UE in radio resource control connected state.

In some examples of the method, UEs, and non-transitory computer-readable medium described herein, the unrestricted downlink BWP may be a dedicated downlink BWP configured by the radio resource control message for a reduced capability (RedCap) or enhanced RedCap (eRedCap) UE in a connected state.

In some examples of the method, UEs, and non-transitory computer-readable medium described herein, the unrestricted downlink BWP may be an initial downlink BWP configured by the system information message for random access by a RedCap or eRedCap UE in an idle or inactive state.

In some examples of the method, UEs, and non-transitory computer-readable medium described herein, a lowest resource block index of the first bandwidth part may be greater than or equal to a resource block index of the first CORESET.

### BRIEF DESCRIPTION OF THE DRAWINGS

FIG. 1 shows an example of a wireless communications system that supports resource allocation indication in unrestricted bandwidth part (BWP) in accordance with one or more aspects of the present disclosure.

FIG. 2 shows an example of a wireless communications system that supports resource allocation indication in unrestricted BWP in accordance with one or more aspects of the present disclosure.

FIG. 3 shows an example of a relative bandwidth comparison that is associated with resource allocation indication in unrestricted BWP in accordance with one or more aspects of the present disclosure.

FIG. 4 shows an example of a relative bandwidth comparison that is associated with resource allocation indication in unrestricted BWP in accordance with one or more aspects of the present disclosure.

FIG. 5 shows an example of a process flow that supports resource allocation indication in unrestricted BWP in accordance with one or more aspects of the present disclosure.

FIGS. 6 and 7 show diagrams of devices that support resource allocation indication in unrestricted BWP in accordance with one or more aspects of the present disclosure.

FIG. 8 shows a diagram of a communications manager that supports resource allocation indication in unrestricted BWP in accordance with one or more aspects of the present disclosure.

FIG. 9 shows a diagram of a system including a device that supports resource allocation indication in unrestricted BWP in accordance with one or more aspects of the present disclosure.

FIGS. 10 and 11 show flowcharts illustrating methods that support resource allocation indication in unrestricted BWP in accordance with one or more aspects of the present disclosure.

### DETAILED DESCRIPTION

In some cases, a user equipment (UE) may support bandwidth part (BWP) operation. A BWP may be a set of common resource blocks (RBs) that are part of a total channel bandwidth configured for a cell. The UE may communicate with a network entity over the BWP. In some instances, a UE (e.g., an eMBB UE, a RedCap UE, or eRedCap UE) may be configured with a dedicated downlink BWP. The dedicated downlink BWP may be configured by a radio resource control (RRC) message or a system information (SI) message. However, a BWP configured by a radio resource control message (RRC) or SI message may not include a control resource set (CORESET), such as a default CORESET #0. Thus, the BWP may have a different bandwidth than the bandwidth of the CORESET #0. A CORESET #0 may include a physical downlink control channel (PDCCH) and downlink control information (DCI) for a SI block (SIB) (e.g., a SIB1). That is, a UE may generally determine resource allocation information (e.g., time and frequency domain resource allocation) based on being configured with a CORESET #0. However, a UE may be configured with a BWP that corresponds to a non-zero CORESET (e.g., a CORESET with a CORESET identification of 1, 2, 3, etc.).

In some examples, a UE may determine resource allocation information when operating on an unrestricted BWP (e.g., an unrestricted downlink BWP that is not associated with a CORESET #0). For example, the UE may operate on a cell that is configured with a CORESET #0 and an unrestricted BWP. The bandwidth of the unrestricted BWP may be equal to, less than, or greater than, the bandwidth of the CORESET #0. Further, a UE may receive control information scheduling a physical downlink shared channel (PDSCH) with a bandwidth within the bandwidth of the unrestricted BWP. The UE may determine a resource indicator value (RIV) to include in a FDRA field based on information corresponding to the CORESET #0, the unrestricted BWP, and the PDSCH. Thus, the UE may communicate (e.g., transmit or receive a message) with a network entity based on the determined RIV.

Aspects of the disclosure are initially described in the context of wireless communications systems, RB index charts, and process flows. Aspects of the disclosure are further illustrated by and described with reference to apparatus diagrams, system diagrams, and flowcharts that relate to resource allocation indication in unrestricted BWP.

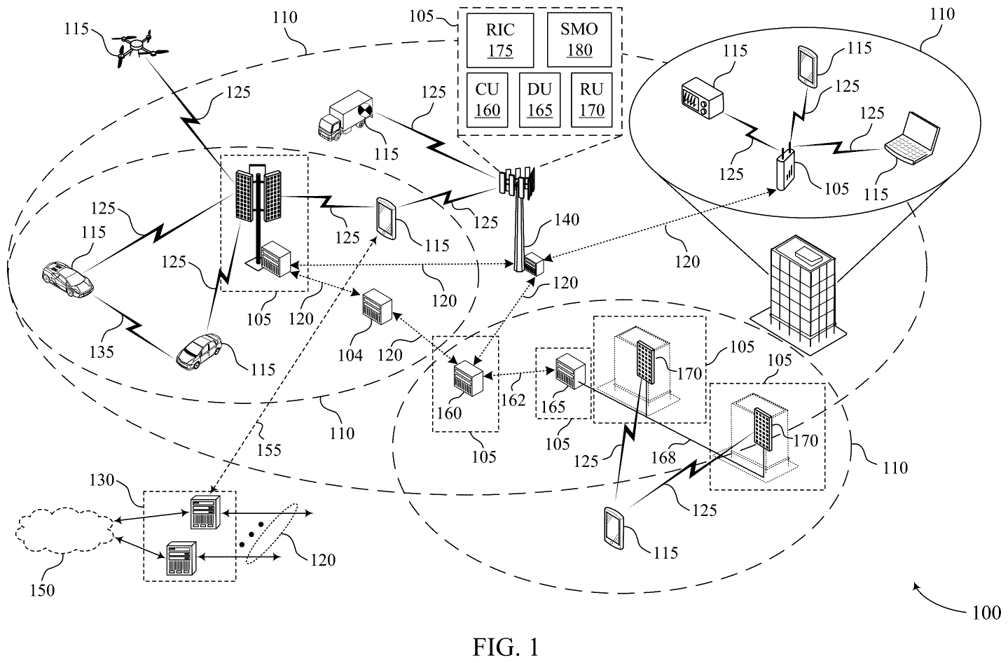

FIG. 1 shows an example of a wireless communications system 100 that supports resource allocation indication in unrestricted BWP in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource allocation indication in unrestricted BWP as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), eMBB) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115 may support BWP operation. A BWP may be a set of common RBs that are part of a total channel bandwidth configured for a cell. The UE 115 may communicate with a network entity 105 over the BWP. In some instances, a UE 115 (e.g., an eMBB UE 115, a RedCap UE 115, or a eRedCap UE 115) may be configured with a dedicated downlink BWP.

In some cases, the dedicated downlink BWP may be configured by a RRC message or a SI message. For example, an eMBB UE 115 may support BWP operation without cell (e.g., a primary cell (PCell), a secondary cell (SCell), and primary and second cells (PSCell) restriction when in a connected state (e.g., the BWP may be configured by an RRC message). Further, the eMBB UE 115 operating in an active BWP that does not include a CORESET #0 may support radio link monitoring (RLM), beam management (BM), and beam failure detection (BFD) measurements based on receiving a cell defining synchronization signal block (CD-SSB) outside the active BWP or a non CD-SSB (NCD-SSB) within the active BWP. In another example, a RedCap UE may support a random access (RA) (e.g., RA based) procedure on a PCell in a RedCap specific initial downlink BWP. The network entity 105 may configure the BWP through an SI message that does not include a SSB or a CORESET #0 when the RedCap UE 115 is in an idle or inactive state. In an additional example, a RedCap UE 115 with an advanced capability may support a downlink BWP without an SSB or a CORESET #0 on a PCell when the RedCap UE 115 is a connected state (e.g., the BWP may be configured by an RRC message). But an unrestricted BWP configured by an RRC or SI message may not include a CORESET #0.

In some cases, a UE 115 may determine resource allocation information (e.g., time and frequency domain resource allocation) based on being configured with a CORESET #0. However, a UE 115 may be configured with an unrestricted BWP that corresponds to a non-zero CORESET (e.g., a CORESET with a CORESET identification of 1, 2, 3, etc.). Additionally, the unrestricted BWP may be associated with a control search space (CSS) including a DCI (e.g., a DCI format 1_0). The DCI format (e.g., decoded in the CSS) may be given by the size of a CORESET #0 (e.g., if a CORESET #0 is configured for a cell) or the size on a downlink BWP (e.g., if a CORESET #0 is not configured for a cell).

A UE 115 operating in an unrestricted BWP may receive DCI (e.g., DCI format 1_0) scheduling a PDSCH. This PDSCH may be scheduled within the bandwidth of the unrestricted BWP. However, downlink resource allocation in the frequency domain may be inefficient when the bandwidth of the CORESET #0 is different than the bandwidth of the unrestricted BWP. For instance, in Type 1 resource allocation, a UE 115 may determine the RIV in a DCI (e.g., DCI 1_0) based on the size of CORESET #0 when the CORESET #0 is configured for a cell (e.g., a cell connected to the UE 115) but not in the unrestricted BWP (e.g., the BWP is configured with a non-zero CORESET). In one example, the bandwidth of the unrestricted BWP may be greater than the bandwidth of the CORESET #0. This may impose a scheduling restriction for a PDSCH which may lead to a loss in reliability (e.g., a loss of frequency diversity gain) and/or throughput (a reduction in transport block size (TBS)). In another example, the bandwidth of the unrestricted BWP may be less than the bandwidth of the CORESET #0. This scenario may lead to ambiguity for PDSCH scheduling and decoding between the network entity 105 and the UE 115. Thus, downlink resource allocation may be clarified so a UE 115 may determine a RIV to include in a FDRA (e.g., in a DCI format 1_0 in CSS) when the UE 115 operates in an unrestricted BWP.

In some cases, a UE 115 may determine resource allocation information when operating on an unrestricted BWP (e.g., an unrestricted downlink BWP that is not associated with a CORESET #0). For example, the UE 115 may operate on a cell that is configured with a CORESET #0 and a unrestricted BWP. The bandwidth of the unrestricted BWP may be equal to, less than, or greater than, the bandwidth of the CORESET #0. Further, a UE 115 may receive control information from a network entity 105 scheduling a PDSCH with a bandwidth within the bandwidth of the unrestricted BWP. The UE 115 may determine (e.g., calculate) a RIV to include in a FDRA field based on information corresponding to the CORESET #0, the unrestricted BWP, and the PDSCH. Thus, the UE 115 may communicate (e.g., transmit or receive a message) with a network entity 105 based on the determined RIV.

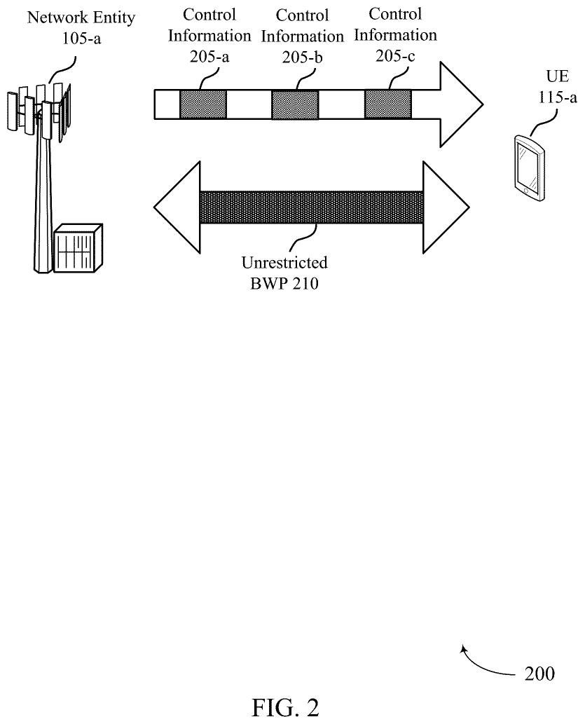

FIG. 2 shows an example of a wireless communications system 200 that supports resource allocation indication in unrestricted BWP in accordance with one or more aspects of the present disclosure. The wireless communications system 200 may implement, or be implemented by, aspects of the wireless communications system 100. For example, the wireless communications system 200 may include a network entity 105-a and a UE 115-a, which may be examples of the UE 115 and the network entity 105 as described with reference to FIG. 1.

The wireless communications system 200 may support communication between the network entity 105-a and the UE 115-a over an unrestricted BWP 210. More specifically, the network entity 105-a may transmit control information 205 to the UE 115-a indicating resource allocation information. The UE 115-a may utilize the control information 205-a to determine a RIV to include in a FDRA field for the unrestricted BWP 210. The FDRA field may be a DCI field associated with FDRA of a PDSCH or physical uplink shared channel (PUSCH) on an active BWP (e.g., uplink or downlink BWP). The size (e.g., bit width) of the FDRA field may depend on the bandwidth of the active BWP or a baseline BWP (e.g., a CORESET #0 or an initial downlink BWP). The RIV in the FDRA field may represent a number that specifies PDSCH and/or PUSCH allocation in DCI (e.g., uplink DCI or downlink DCI).

In some cases, the network entity 105-a may transmit control information 205-a to the UE 115-a indicating a CORESET #0 associated with SI acquisition. The CORESET #0 may be a CORESET with an ID of 0 and be configured by a master information block (MIB) of a CD-SSB. The CORESET #0 may be associated with SI (e.g., SIB1) acquisition. In some instances, the UE 115-a may be an eMBB UE or a RedCap UE in an idle (e.g., inactive) state. In at least these instances, the CORESET #0 may be a default initial downlink BWP.

In some cases, the network entity 105-a may transmit control information 205-b to the UE 115-a indicating an unrestricted BWP 210 that is configured with a non-zero CORESET (e.g., a CORESET different then CORESET #0). The CORESET configured for the unrestricted BWP 210 may have a different bandwidth than the bandwidth for the CORESET #0. In some instances, the UE 115-a may be an eMBB UE in an RRC connected state. In these instances, an RRC message may configure the unrestricted BWP 210 (e.g., a dedicated downlink BWP). In some other instances, the UE 115-a may be an RedCap or eRedCap UE in a connected state. In these instances, an RRC message may configure the unrestricted BWP 210 (e.g., a dedicated downlink BWP). Additionally, or alternatively, the UE 115-a may be a RedCap or eRedCap UE in an idle or inactive state. In these instances, an SI message for random access may configure the unrestricted BWP 210 (e.g., an initial downlink BWP). That is, the unrestricted BWP 210 may represent a BWP that is configured in at least one of the above instances. However, the SI message and the RRC message may not contain a CORESET #0 associated with SIB1 acquisition.

In some cases, the network entity 105-a may transmit control information 205-c to the UE 115-a. The control information 205-c may include DCI (e.g., DCI 1_0) which may carry the scheduling information of a PDSCH. This control information 205-c may include fields for FDRA and modulation and coding schemes (MCS) among other examples. The control information 205-c may indicate a bandwidth and first RB associated with the PDSCH. The bandwidth associated with the PDSCH may lie within the bandwidth of the unrestricted BWP 210. This first RB may be the lowest RB index of the physical downlink shared channel. Additionally, or alternatively, the value of the first RB may be greater than or equal to a lowest RB index of the unrestricted BWP 210.

In some cases, the UE 115-a may operate on a cell that is configured with a CORESET #0 and an unrestricted BWP 210. The network entity 105-a may restrict (e.g., bound) the bandwidth of the unrestricted BWP 210. The network entity may configure the bandwidth of the unrestricted BWP 210 (e.g., through the control information 205-b) to be lower bounded by the bandwidth of the CORESET #0. In other words, a lowest RB index of the CORESET #0 may be greater than or equal to a lowest RB index (e.g., a first RB) of the unrestricted BWP 210. Thus, the UE 115-a may not operate on an unrestricted BWP 210 with a bandwidth smaller than the bandwidth of the CORESET #0.

Additionally, or alternatively, the UE 115-a may determine a RIV to include in a FDMA field for the unrestricted BWP based on the unrestricted BWP 210 being configured with a CORESET different then the CORESET #0. Further, the UE 115-a may determine (e.g., calculate) the RIV using resource allocation information from the control information 205-a, the control information 205-b, the control information 205-c, or any combination thereof. In some cases, the UE 115-a and the network entity 105- may communicate via (e.g., across or over) the unrestricted BWP 210 based on the determined RIV. More specifically, the UE 115-a and the network entity 105- may communicate via the unrestricted BWP 210 regardless of whether the bandwidth of the CORESET #0 is the same as the bandwidth of the unrestricted BWP 210.

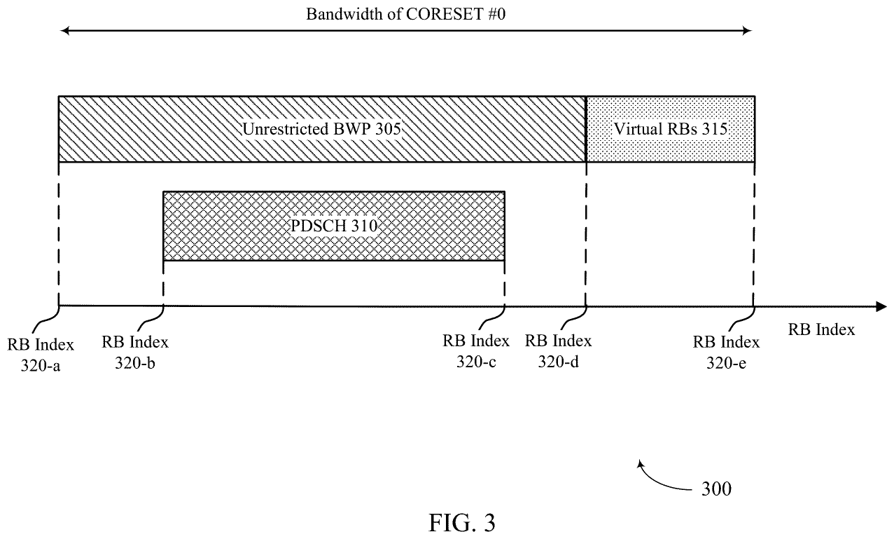

FIG. 3 shows an example of a relative bandwidth comparison 300 that is associated with resource allocation indication in unrestricted BWP in accordance with one or more aspects of the present disclosure. In some examples, the relative bandwidth comparison 300 may implement or be implemented by aspects of the wireless communications system 100 or the wireless communications system 200.

The relative bandwidth comparison 300 may illustrate one or more RB index configurations. For example, the relative bandwidth comparison 300 may include respective RB index configurations for an unrestricted BWP 305, a CORESET #0, and a PDSCH 310. Although described as particular RB index configurations for illustrative purposes, the respective RB index configurations for the unrestricted BWP 305, the CORESET #0, and the PDSCH 310 may be any quantity of RBs and in any order or configuration.

In some cases, the bandwidth of the of the CORESET #0 may be larger than the bandwidth of the unrestricted BWP 305. For example, the bandwidth of the CORESET #0 (e.g., CORESET associated with SIB1 acquisition) may be N RBs and may be equal to a virtual bandwidth N_{BWP}^{size}. For example, the bandwidth of the CORESET #0 may span from a RB index 320-a to a RB index 320-e. The bandwidth of the unrestricted BWP 305 may span from the RB index 320-a to a RB index 320-d. That is, the bandwidth of the CORESET #0 may span across the bandwidth of the unrestricted BWP 305 and one or more virtual RBs 315. The virtual RBs 315 may represent an index of virtual RBs that are nor applicable for PDSCH scheduling (e.g., the PDSCH 310 may not be scheduled within the virtual RBs 315).

In some cases, the bandwidth of the PDSCH may lie within the bandwidth of the unrestricted BWP 305. For example, the bandwidth of the PDSCH 310 may span from a RB index 320-b to a RB index 320-c. A network entity may restrict the configuration for a lowest RB index (RBₛₜₐᵣₜ) (e.g., RB index 320-b) and bandwidth (L_{RBs}) (e.g., the bandwidth from the RB index 320-b to the RB index 320-c) assigned to the PDSCH 310. The network entity may configure RBₛₜₐᵣₜ to be greater than or equal to the lowest RB index configured for the unrestricted BWP 305 (e.g., the RB index 320-a). Additionally, the network entity may configure L_{RBs} to be greater than or equal to one where L_{RBs}−1+RBₛₜₐᵣₜ corresponds to the highest RB index configured for the PDSCH 310 (e.g., the RB index 320-c). The RB index 320-c may be less than or equal to the minimum of RB index 320-d (e.g., the highest RB index configured for the unrestricted BWP 305) or N_{BWP}^{size}−RBₛₜₐᵣₜ. Thus, the network entity may restrict the RBₛₜₐᵣₜ and the L_{RBs} associated with the PDSCH 310 for DCI size alignment with the CORESET #0.

In some cases, a UE may determine a RIV to include in a FDRA field for the unrestricted BWP 305 based on the unrestricted BWP 305 being configured with a CORESET that is different than the CORESET #0. The UE may determine the virtual bandwidth N_{BWP}^{size} (e.g., the bandwidth of the CORESET #0) and the bandwidth of the PDSCH L_{RBs}. The UE may then determine (e.g., calculate) the RIV following the formula illustrated below by Equation 1.

$$if {L}_{RBs} - 1 \leq [ {N}_{BWP}^{size} / 2 ] \qquad ( 1 )$$

$$then$$

$$RIV = {N}_{BWP}^{size} ( {L}_{RBs} - 1 ) + {RB}_{start}$$

Otherwise, if L_{RBs}−1>[N_{BWP}^{size}/2], the UE may determine the RIV following the formula illustrated below by Equation 2.

$$RIV = {N}_{BWP}^{size} ( {N}_{BWP}^{size} - {L}_{RBs} + 1 ) + ( {N}_{BWP}^{size} - 1 - {RB}_{start} ) \qquad ( 2 )$$

The UE may fill in the FDRA field (e.g., of a DCI 1_0) with the determined RIV. A size of the FDRA field may be illustrated below by Equation 3 where N is the quantity of RBs belonging to CORESET #0 and L represents the size of the FDRA bits.

$$L = [ {log}_{2} N ( N + 1 ) / 2 ] \qquad ( 3 )$$

In some cases, the UE may include (e.g., add) a padding of bits to the FDRA field. For example, a virtual bandwidth N_{BWP}^{size} may be equal to the bandwidth of the unrestricted BWP 305 (e.g., the quantity of RBs belonging to the unrestricted BWP 305). A network entity may restrict the configuration for RBₛₜₐᵣₜ (e.g., the lowest RB index assigned for the PDSCH 310) and L_{RBs} (e.g., the bandwidth assigned for the PDSCH 310). The network entity may configure RBₛₜₐᵣₜ to be greater than or equal to the lowest RB index configured for the unrestricted BWP 305. Additionally, the network entity may configure L_{RBs} to be greater than or equal to one where L_{RBs}−1+RBₛₜₐᵣₜ corresponds to the highest RB index configured for the PDSCH 310. The highest RB index configured for the PDSCH 310 may be less than or equal to N_{BWP}^{size}−RBₛₜₐᵣₜ. The UE may then calculate the RIV following Equations 1 and 2 above. Thus, the UE may determine the RIV using the virtual bandwidth (e.g., the bandwidth of the unrestricted BWP), RBₛₜₐᵣₜ, and L_{RBs}.

In some cases, the UE may calculate one or more bit widths. For example, the UE may calculate a first bit width (e.g., L) following Equation 3 above. Further, the UE may calculate a second bit width (e.g., L*) representing the bit width of the determined (e.g., calculated) RIV. The UE may compare the quantity of bits in the first bit width to the quantity of bits in the second bit width. If the first bit width is equal to the second bit width, the UE may include the determined RIV value in the FDRA field. Alternatively, if the first bit width is greater than the second bit width, The UE may include the determined RIV value in the FDRA field and pad bits to the FDRA bits. The padded bits may be equal to a difference between the first bit width and the second bit width (e.g., L minus L* bits). The UE may include the padded bits at the beginning, or at the end, of the FDRA field. That is, the UE may include the padded bits before or after, the RIV in the FDRA field.

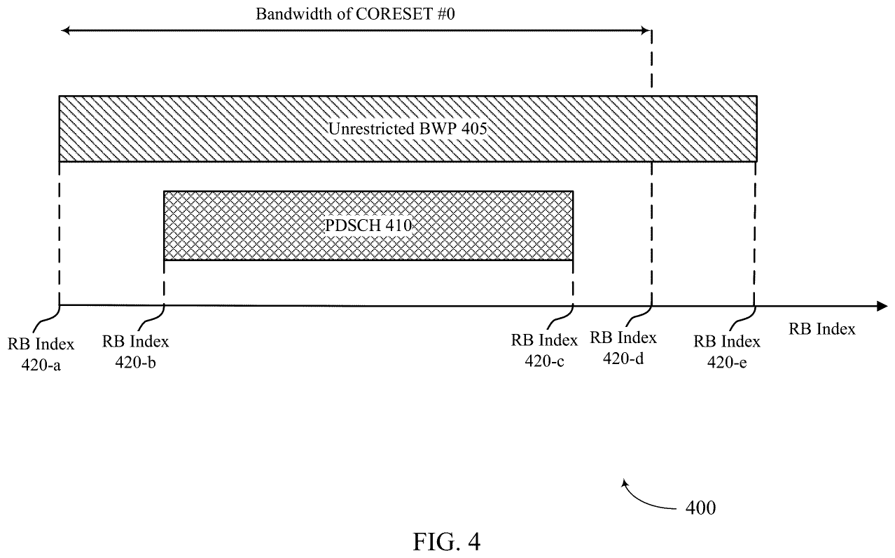

FIG. 4 shows an example of a relative bandwidth comparison 400 that is associated with resource allocation indication in unrestricted BWP in accordance with one or more aspects of the present disclosure. In some examples, the relative bandwidth comparison 400 may implement or be implemented by aspects of the wireless communications system 100, or the wireless communications system 200.

The relative bandwidth comparison 400 may illustrate one or more RB index configurations. For example, the relative bandwidth comparison 400 may include respective RB index configurations for an unrestricted BWP 405, a CORESET #0, and a PDSCH 410. Although described as particular RB index configurations for illustrative purposes, the respective RB index configurations for the unrestricted BWP 405, the CORESET #0, and the PDSCH 410 may be any quantity of RBs in any order or configuration.

In some cases, the bandwidth of the of the CORESET #0 may be smaller than the bandwidth of the unrestricted BWP 405. For example, the bandwidth of the CORESET #0 (e.g., CORESET associated with SIB1 acquisition) may be N RBs and may be equal to a virtual bandwidth N_{BWP}^{size}. For example, the bandwidth of the CORESET #0 may span from a RB index 420-a to a RB index 420-d. The bandwidth of the unrestricted BWP 405 may span from the RB index 320-a to a RB index 420-c. That is, the bandwidth of the CORESET #0 may span across a portion of the bandwidth of the unrestricted BWP 305.

In some cases, the bandwidth of the PDSCH 410 may lie within the bandwidth of the unrestricted BWP 405. For example, the bandwidth of the PDSCH 410 may span from a RB index 420-b to a RB index 420-c. A network entity may restrict the configuration for a lowest RB index (RBₛₜₐᵣₜ) (e.g., the RB index 420-b) and bandwidth (L_{RBs}) (e.g., the bandwidth from the RB index 420-b to the RB index 420-c) assigned to the PDSCH 310. The network entity may configure RBₛₜₐᵣₜ to be greater than or equal to the lowest RB index configured for the unrestricted BWP 405 (e.g., the RB index 420-a). Additionally, the network entity may configure L_{RBs} to be greater than or equal to one where L_{RBs}−1+RBₛₜₐᵣₜ corresponds to the highest RB index configured for the PDSCH 410 (e.g., the RB index 420-c). The RB index 420-c may be less than or equal to N_{BWP}^{size}−RBₛₜₐᵣₜ. Thus, the network entity may restrict the RBₛₜₐᵣₜ and the L_{RBs} associated with the PDSCH 410 for DCI size alignment with the CORESET #0.

In some cases, a UE may determine a RIV to include in a FDRA field for the unrestricted BWP 405 based on the unrestricted BWP 405 being configured with a CORESET that is different than CORESET #0. The UE may determine the virtual bandwidth N_{BWP}^{size} (e.g., the bandwidth of the CORESET #0) and the bandwidth of the PDSCH 410 L_{RBs}. The UE may then determine (e.g., calculate) the RIV following the formula illustrated below by Equation 4.

$$if ( {L}_{RBs} - 1 ) \leq [ {N}_{BWP}^{size} / 2 ] \qquad ( 4 )$$

$$RIV = {N}_{BWP}^{size} ( {L}_{RBs} - 1 ) + {RB}_{start}$$

Otherwise, if L_{RBs}−1>[N_{BWP}^{size}/2], the UE may determine (e.g., calculate) the RIV following the formula illustrated below by Equation 5.

$$RIV = {N}_{BWP}^{size} ( {N}_{BWP}^{size} - {L}_{RBs} + 1 ) + ( {N}_{BWP}^{size} - 1 - {RB}_{start} ) \qquad ( 5 )$$

The UE may fill in the FDRA field (e.g., of a DCI 1_0) with the calculated RIV.

A size of the FDRA field may be illustrated below by Equation 6 where N is the quantity of RBs belonging to CORESET #0 and L represents the size of the FDRA bits.

$$L = [ {log}_{2} N ( N + 1 ) / 2 ] \qquad ( 6 )$$

In some cases, the UE may truncate (e.g., shorten) the RIV in the FDRA field. For example, a virtual bandwidth N_{BWP}^{size} may be equal to the bandwidth of the unrestricted BWP 405 (e.g., the quantity of RBs belonging to the unrestricted BWP 405). A network entity may restrict the configuration for RBₛₜₐᵣₜ (e.g., the lowest RB index assigned for the PDSCH 410) and L_{RBs} (e.g., the bandwidth assigned for the PDSCH 410). The network entity may configure RBₛₜₐᵣₜ to be greater than or equal to the lowest RB index configured for the unrestricted BWP 405. Additionally, the network entity may configure L_{RBs} to be greater than or equal to one where L_{RBs}−1+RBₛₜₐᵣₜ corresponds to the highest RB index configured for the PDSCH 410. The highest RB index configured for the PDSCH 410 may be less than or equal to N_{BWP}^{size}−RBₛₜₐᵣₜ. The UE may then calculate the RIV following Equations 4 and 5 above. Thus, the UE may determine the RIV using the virtual bandwidth (e.g., the bandwidth of the unrestricted BWP), RBₛₜₐᵣₜ, and L_{RBs}.

In some cases, the UE may calculate one or more bit widths. For example, the UE may calculate a first bit width (e.g., L) following Equation 6 above. Further, the UE may calculate a second bit width (e.g., L*) representing the bit width of the determined (e.g., calculated) RIV. The UE may compare the quantity of bits in the first bit width to the quantity of bits in the second bit width. If the first bit width is equal to the second bit width, the UE may include the determined RIV value in the FDRA field. Alternatively, if the first bit width is smaller than the first bit width, the UE may include a truncated value of the RIV value (e.g., a truncated RIV) in the FDRA field. For example, the truncated RIV may be equal to a difference between the second bit width and the first bit width (e.g., L* minus L bits). The UE may truncate the bits for the most significant bit (MSB) (e.g., bits at the beginning of the determined RIV) or least significant bit (LSB) (e.g., bits at the end of the determined RIV) of a binary array. In other words, the UE may truncate the MSBs and/or the LSBs (e.g., of the determined RIV) which may not map to the FDRA field.

In some cases, the size of the FDRA field (e.g., of DCI 1_0 in a CSS) may be a fixed bit width associated with CORESET #0 regardless of the bit width of the unrestricted BWP 405. A fixed FDRA bit width may simplify UE procedures for DCI decoding, RIV interpretation, BWP switching, or any combination thereof. However, the fixed FDRA bit width may lead to losses in scheduling flexibility, frequency diversity gain, and throughput. In some other cases, a FDRA field may have a variable bit width (e.g., a bit width associated with the bandwidth of the active unrestricted BWP 405). A variable FDRA bit width may improve scheduling flexibility and throughput while leading to a higher frequency diversity gain. However, the variable FDRA bit width may increase the complexity of DCI decoding, RIV interpretation, and BWP switching for a UE.

In some cases, the UE may determine the size of the FDRA field and the RIV transmitted in an unrestricted BWP 405 according to the size of the unrestricted BWP 405 (e.g., actual size of the unrestricted downlink BWP 405) and regardless of the size of the CORESET #0. For example, the size of the FDRA field in the DCI (e.g., DCI 1_0) is illustrated by Equation 7 below where N_{RB}^{DL, BWP} is the size (e.g., quantity of RBs) of the unrestricted BWP 405 and L represents the size of the FDRA field:

$$L = [ {log}_{2} {N}_{RB}^{DL , BWP} ( {N}_{RB}^{DL , BWP} + 1 ) / 2 ] \qquad ( 7 )$$

In some cases, a virtual bandwidth N_{BWP}^{size} may be equal to the bandwidth of the unrestricted BWP 405. A network entity may restrict the configuration for RBₛₜₐᵣₜ (e.g., the lowest RB index assigned for the PDSCH 410) and L_{RBs} (e.g., the bandwidth assigned for the PDSCH 410). The network entity may configure RBₛₜₐᵣₜ to be greater than or equal to the lowest RB index configured for the unrestricted BWP 405. Additionally, the network entity may configure L_{RBs} to be greater than or equal to one where L_{RBs}−1+RBₛₜₐᵣₜ corresponds to the highest RB index configured for the PDSCH 410. The highest RB index configured for the PDSCH may be less than or equal to N_{BWP}^{size}−RBₛₜₐᵣₜ. Thus, the network entity may restrict the RBₛₜₐᵣₜ and the L_{RBs} according to the size of the unrestricted BWP 405.

In some cases, a UE may determine a RIV to include in a FDRA field for the unrestricted BWP 405 based on the actual size of the unrestricted downlink BWP 405. The UE may determine the virtual bandwidth N_{BWP}^{size} (e.g., the bandwidth of the unrestricted BWP 405) and the bandwidth of the PDSCH 410 (e.g., L_{RBs}). The UE may then determine (e.g., calculate) the RIV following the formula illustrated below by Equation 8.

$$if ( {L}_{RBs} - 1 ) \leq [ {N}_{BWP}^{size} / 2 ] \qquad ( 8 )$$

$$then$$

$$RIV = {N}_{BWP}^{size} ( {L}_{RBs} - 1 ) + {RB}_{start}$$

Otherwise, if L_{RBs}−1>[N_{BWP}^{size}/2], the UE may determine (e.g., calculate) the RIV following the formula illustrated below by Equation 9.

$$RIV = {N}_{BWP}^{size} ( {N}_{BWP}^{size} - {L}_{RBs} + 1 ) + ( {N}_{BWP}^{size} - 1 - {RB}_{start} ) \qquad ( 9 )$$

The UE may fill in the FDRA field (e.g., of a DCI 1_0) with the calculated RIV from Equation 8 or 9.

In some cases, the UE may determine the RIV to include in the FDRA field using RB grouping. For example, the UE may determine the RIV to include in the FDRA field using RB grouping when the bandwidth of the unrestricted BWP 405 is greater than the bandwidth of a baseline BWP. The baseline BWP may be either a CORESET #0 or a different narrow-band downlink BWP with a non-zero CORESET.

In some cases, the UE may determine (e.g., calculate) a size of a RB group K following Equation 10 as illustrated below.

$$K = ⌈ \frac{{N}_{BWP}^{un - restricted}}{{N}_{BWP}^{baseline}} ⌉ \qquad ( 10 )$$

In Equation 10, N_{BWP}^{un-restricted} may represent the bandwidth of the active unrestricted BWP 405 while N_{BWP}^{baseline} may represent the bandwidth of the baseline BWP (e.g., an initial downlink BWP with a non-zero CORESET).

The network entity may configure RBₛₜₐᵣₜ to be in the range of {0, K, 2K, . . . , (N_{BWP}^{baseline}−1)K} and define RBₛₜₐᵣₜ^{*} according to Equation 11 as illustrated below.

$${RB}_{start}^{*} = ⌈ \frac{{RB}_{start}}{K} ⌉ \qquad ( 11 )$$

Additionally, or alternatively, the network entity may configure L_{RBs} in terms of contiguously allocated RB groups. For example, the network entity may configure L_{RBs} to be in the range of {K, 2K, . . . , (N_{BWP}^{baseline})K} and define L_{RBs}^{*} according to Equation 12 as illustrated below.

$${L}_{RBs}^{*} = \frac{{L}_{RBs}}{K} \qquad ( 11 )$$

L_{RBs}^{*} may be less than or equal to N_{BWP}^{baseline}−RBₛₜₐᵣₜ^{*}.

In some cases, the UE may then determine (e.g., calculate) the RIV following the formula illustrated below by Equation 12.

$$if {L}_{RBs}^{*} \leq \frac{{N}_{BWP}^{baseline}}{2} + 1 \qquad ( 12 )$$

$$then$$

$$RIV = {N}_{BWP}^{baseline} ( {L}_{RBs}^{*} - 1 ) + R {B}_{start}^{*}$$

### Otherwise, if

$${L}_{RBs}^{*} > \frac{{N}_{BWP}^{baseline}}{2} + 1 ,$$

the UE may determine the RIV following the formula illustrated below by Equation 13.

$$RIV = {N}_{BWP}^{baseline} ( {N}_{BWP}^{baseline} - {L}_{RBs}^{*} + 1 ) + ( {N}_{BWP}^{baseline} - 1 - {RB}_{start}^{*} ) \qquad ( 13 )$$

The UE may fill in the FDRA field (e.g., of a DCI 1_0) with the calculated RIV from Equations 12 or 13. Thus, the UE may determine the RIV to include in the FDRA field using RB group information (e.g., the size of a RB group). The size of the FDRA field transmitted in the active unrestricted BWP 405 may align with the size of the FDRA field of the DCI transmitted in the baseline BWP.

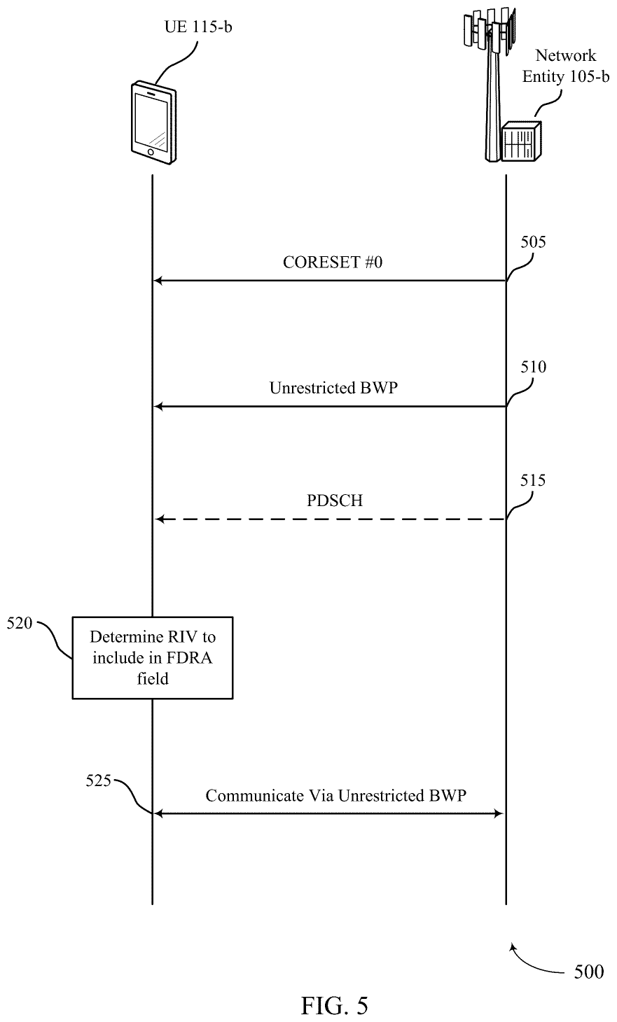

FIG. 5 shows an example of a process flow 500 that supports resource allocation indication in unrestricted BWP in accordance with one or more aspects of the present disclosure. The process flow 500 may implement, or be implemented by, aspects of the wireless communications system 100, the wireless communications system 200, the relative bandwidth comparison 300, or the relative bandwidth comparison 400. The process flow 500 may include a UE 115-b and a network entity 105-b, which may be examples of a UE 115 and a network entity 105, respectively, as described herein. In the following description of the process flow 500, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 500, and other operations may be added to the process flow 500.

At 505, the UE 115-b may receive first control information, from the network entity 105-b, indicating a first CORESET associated with SI acquisition. The first CORESET may be a CORESET #0 with a first bandwidth.

At 510, the UE 115-b may receive second control information, from the network entity 105-b, indicating a first BWP (e.g., an unrestricted BWP). The network entity 105-b may configure the unrestricted BWP with a second CORESET that is different from the first CORESET (e.g., the CORESET configured for the unrestricted BWP is not a CORESET #0). The unrestricted BWP may have a second bandwidth. The second bandwidth may be equal to, greater than, or less than, the first bandwidth.

At 515, the UE 115-b may receive third control information, from the network entity 105-b, scheduling a PDSCH. The network entity 105-b may configure the PDSCH with a third bandwidth and a first RB. The third bandwidth may lie within the second bandwidth. The first RB may be a lowest RB index of the PDSCH and a value for the first RB may be greater than or equal to a lowest RB of the unrestricted BWP. That is, the PDSCH may be lower-bounded by the unrestricted BWP.

At 520, the UE 115-b may determine a RIV to include in a FDRA field for the unrestricted BWP based on the unrestricted BWP being configured with a non-zero CORESET. The UE may determine (e.g., calculate) the RIV based on information corresponding to the CORESET #0, the unrestricted BWP, the PDSCH, or any combination thereof.

At 525, the UE 115-b and the network entity 105-b may communicate via the unrestricted BWP based on the RIV. That is, the UE 115-b and the network entity 105-b may transmit messages to (e.g., receive messages from) each other via the unrestricted BWP using the RIV included in the FDRA field of the unrestricted BWP.

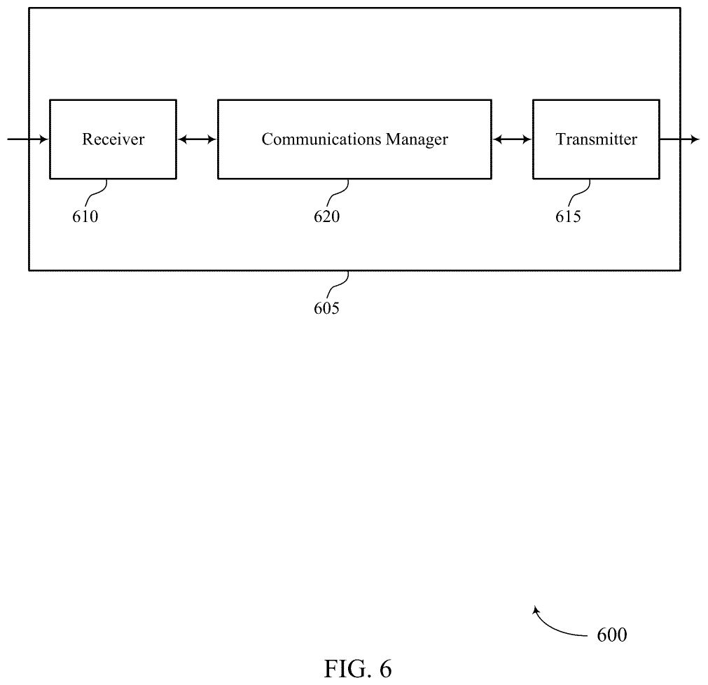

FIG. 6 shows a diagram 600 of a device 605 that supports resource allocation indication in unrestricted BWP in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to resource allocation indication in unrestricted BWP). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to resource allocation indication in unrestricted BWP). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of resource allocation indication in unrestricted BWP as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving first control information indicating a first CORESET associated with SI acquisition, the first CORESET having a first bandwidth. The communications manager 620 is capable of, configured to, or operable to support a means for receiving second control information indicating a first BWP that is configured with a second CORESET that is different than the first CORESET, where the first BWP has a second bandwidth. The communications manager 620 is capable of, configured to, or operable to support a means for determining a RIV to include in a FDRA field for the first BWP based at least in part on the first BWP being configured with a CORESET that is different from the first CORESET. The communications manager 620 is capable of, configured to, or operable to support a means for communicating, via the first BWP, based on the RIV.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and more efficient utilization of communication resources.

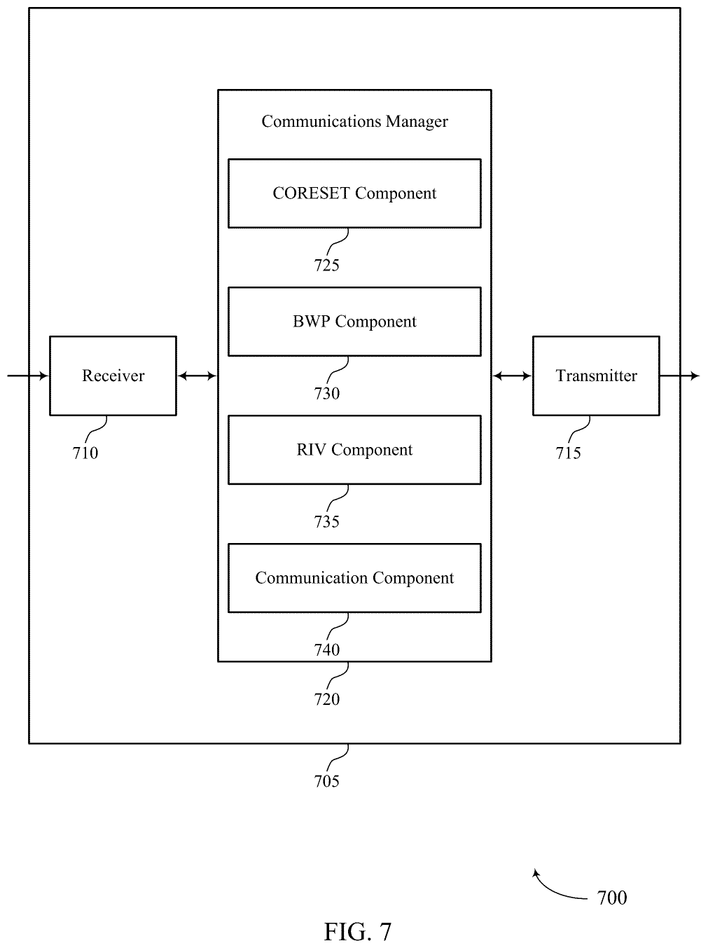

FIG. 7 shows a diagram 700 of a device 705 that supports resource allocation indication in unrestricted BWP in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to resource allocation indication in unrestricted BWP). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource allocation indication in unrestricted BWP). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of resource allocation indication in unrestricted BWP as described herein. For example, the communications manager 720 may include a CORESET component 725, a BWP component 730, a RIV component 735, a communication component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The CORESET component 725 is capable of, configured to, or operable to support a means for receiving first control information indicating a first CORESET associated with SI acquisition, the first CORESET having a first bandwidth. The BWP component 730 is capable of, configured to, or operable to support a means for receiving second control information indicating a first BWP that is configured with a second CORESET that is different than the first CORESET, where the first BWP has a second bandwidth. The RIV component 735 is capable of, configured to, or operable to support a means for determining a RIV to include in a FDRA field for the first BWP based at least in part on the first BWP being configured with a CORESET that is different from the first CORESET. The communication component 740 is capable of, configured to, or operable to support a means for communicating, via the first BWP, based on the RIV.

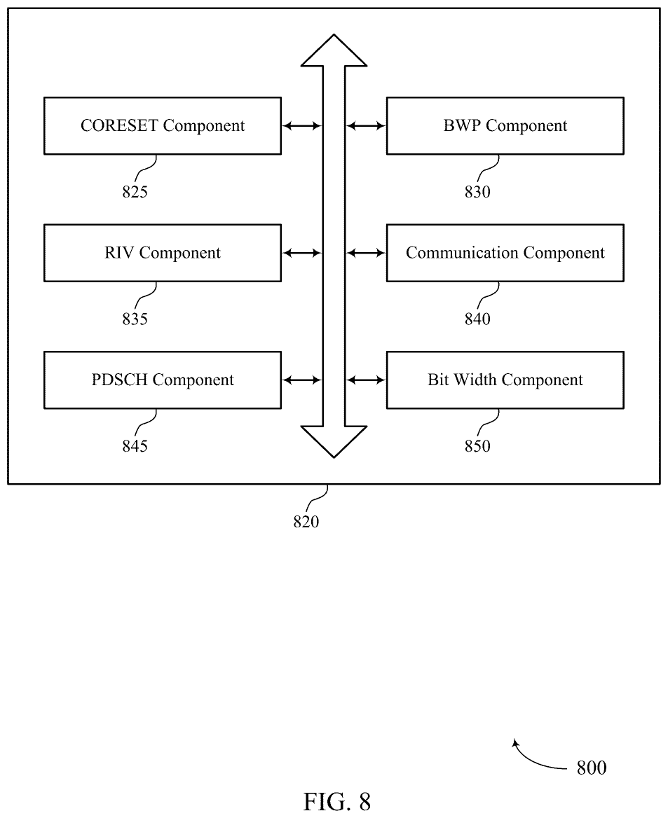

FIG. 8 shows a diagram 800 of a communications manager 820 that supports resource allocation indication in unrestricted BWP in accordance with one or more aspects of the present disclosure. The communications manager 820 may be an example of aspects of a communications manager 620, a communications manager 720, or both, as described herein. The communications manager 820, or various components thereof, may be an example of means for performing various aspects of resource allocation indication in unrestricted BWP as described herein. For example, the communications manager 820 may include a CORESET component 825, a BWP component 830, a RIV component 835, a communication component 840, a physical downlink shared channel component 845, a bit width component 850, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The CORESET component 825 is capable of, configured to, or operable to support a means for receiving first control information indicating a first CORESET associated with SI acquisition, the first CORESET having a first bandwidth. The BWP component 830 is capable of, configured to, or operable to support a means for receiving second control information indicating a first BWP that is configured with a second CORESET that is different than the first CORESET, where the first BWP has a second bandwidth. The RIV component 835 is capable of, configured to, or operable to support a means for determining a RIV to include in a FDRA field for the first BWP based at least in part on the first BWP being configured with a CORESET that is different from the first CORESET. The communication component 840 is capable of, configured to, or operable to support a means for communicating, via the first BWP, based on the RIV.

In some examples, the physical downlink shared channel component 845 is capable of, configured to, or operable to support a means for receiving third control information scheduling a physical downlink shared channel associated with a third bandwidth and a first RB, where the third bandwidth lies within the second bandwidth, and where the first RB is a lowest RB index of the physical downlink shared channel and a value for the first RB is greater than or equal to a lowest RB index of the first BWP.

In some examples, the first bandwidth is larger than the second bandwidth.

In some examples, to support determining the RIV, the RIV component 835 is capable of, configured to, or operable to support a means for determining a virtual bandwidth and the third bandwidth of the physical downlink shared channel, where the virtual bandwidth is equal to the first bandwidth, and a highest RB index of the physical downlink shared channel is equal to or less than a minimum of a highest RB index of the first BWP or a difference between the virtual bandwidth and the value for the first RB, where the RIV is determined using the virtual bandwidth, the value of the first RB, and the third bandwidth.

In some examples, to support determining the RIV, the RIV component 835 is capable of, configured to, or operable to support a means for determining a virtual bandwidth and the third bandwidth of the physical downlink shared channel, where the virtual bandwidth is equal to the second bandwidth, and a highest RB index of the physical downlink shared channel is equal to or less than a difference between the virtual bandwidth and the value for the first RB, and where the RIV is determined using the virtual bandwidth, the value of the first RB, and the third bandwidth.

In some examples, to support determining the RIV, the bit width component 850 is capable of, configured to, or operable to support a means for calculating a first bit width based on a number of RBs of the first CORESET, where a second bit width is a bit width of the RIV. In some examples, to support determining the RIV, the RIV component 835 is capable of, configured to, or operable to support a means for including the RIV in the FDRA field if the second bit width is equal to the first bit width, or including the RIV and a padding of bits in the FDRA field if the second bit width is less than the first bit width, where the padding of bits is equal to a difference between the first bit width and the second bit width.

In some examples, the second bandwidth is larger than the first bandwidth. In some examples, to support determining the RIV, the RIV component 835 is capable of, configured to, or operable to support a means for determining a virtual bandwidth and the third bandwidth of the physical downlink shared channel, where the virtual bandwidth is equal to the first bandwidth, and a highest RB index of the physical downlink shared channel is equal to or less than a difference between the virtual bandwidth and the value for the first RB, and where the RIV is determined using the virtual bandwidth, the value of the first RB, and the third bandwidth.

In some examples, to support determining the RIV, the RIV component 835 is capable of, configured to, or operable to support a means for determining a virtual bandwidth and the third bandwidth of the physical downlink shared channel, where the virtual bandwidth is equal to the second bandwidth, and a highest RB index of the physical downlink shared channel is equal to or less than a difference between the virtual bandwidth and the value for the first RB, and where the RIV is determined using the virtual bandwidth, the value of the first RB, and the third bandwidth.

In some examples, to support determining the RIV, the bit width component 850 is capable of, configured to, or operable to support a means for calculating a first bit width based on the first CORESET, where a second bit width is a bit width of the RIV. In some examples, to support determining the RIV, the RIV component 835 is capable of, configured to, or operable to support a means for including the RIV in the FDRA field if the second bit width is equal to the first bit width, or including the RIV and a truncated RIV in the FDRA field if the second bit width is greater than the first bit width, where the truncated RIV is equal to a difference between the second bit width and the first bit width.

In some examples, to support determining the RIV, the RIV component 835 is capable of, configured to, or operable to support a means for determining a virtual bandwidth and the third bandwidth of the physical downlink shared channel, where the virtual bandwidth is equal to the second bandwidth, and a highest RB index of the physical downlink shared channel is equal to or less than a difference between the virtual bandwidth and the value for the first RB, and where the RIV is determined using the virtual bandwidth, a size of the first BWP, the value of the first RB, and the third bandwidth.

In some examples, to support determining the RIV, the RIV component 835 is capable of, configured to, or operable to support a means for determining a size of a RB group based on the second bandwidth and a baseline bandwidth, where the baseline bandwidth is equal to the first bandwidth or a fourth bandwidth associated with a second BWP, and where the RIV is determined using at least the size of the RB group.

In some examples, the first CORESET has a CORESET identification of zero. In some examples, to support receiving the second control information indicating the first BWP, the BWP component 830 is capable of, configured to, or operable to support a means for receiving the second control information over a RRC message or a SI message, where the first BWP is an unrestricted downlink BWP that is not associated with the first CORESET.

In some examples, the unrestricted downlink BWP is a dedicated downlink BWP configured by the RRC message for an eMBB UE in radio resource control connected state. In some examples, the unrestricted downlink BWP is a dedicated downlink BWP configured by the RRC message for a RedCap or eRedCap UE in a connected state.

In some examples, the unrestricted downlink BWP is an initial downlink BWP configured by the SI message for random access by a RedCap or eRedCap UE in an idle or inactive state. In some examples, a lowest RB index of the first BWP is greater than or equal to a RB index of the first CORESET.

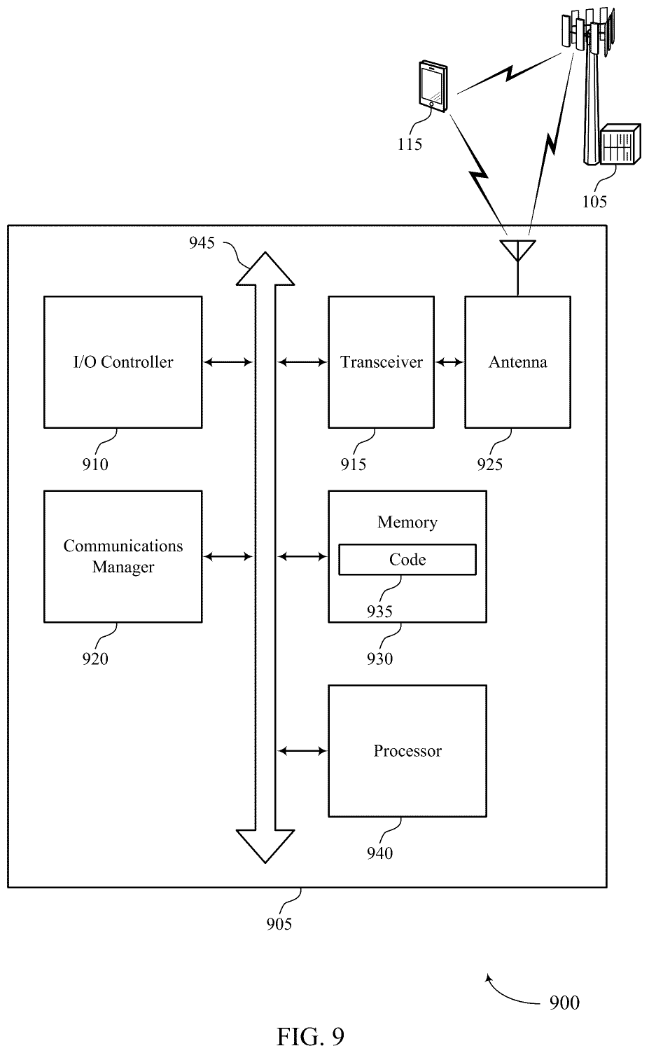

FIG. 9 shows a diagram of a system 900 including a device 905 that supports resource allocation indication in unrestricted BWP in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting resource allocation indication in unrestricted BWP). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving first control information indicating a first CORESET associated with SI acquisition, the first CORESET having a first bandwidth. The communications manager 920 is capable of, configured to, or operable to support a means for receiving second control information indicating a first BWP that is configured with a second CORESET that is different than the first CORESET, where the first BWP has a second bandwidth. The communications manager 920 is capable of, configured to, or operable to support a means for determining a RIV to include in a FDRA field for the first BWP based at least in part on the first BWP being configured with a CORESET that is different from the first CORESET. The communications manager 920 is capable of, configured to, or operable to support a means for communicating, via the first BWP, based on the RIV.

By including or configuring the communications manager 920 in accordance with examples as described herein, the device 905 may support techniques for improved user experience related to reduced processing, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of resource allocation indication in unrestricted BWP as described herein, or the at least one processor 940 and the at least one memory 930 may be otherwise configured to, individually or collectively, perform or support such operations.

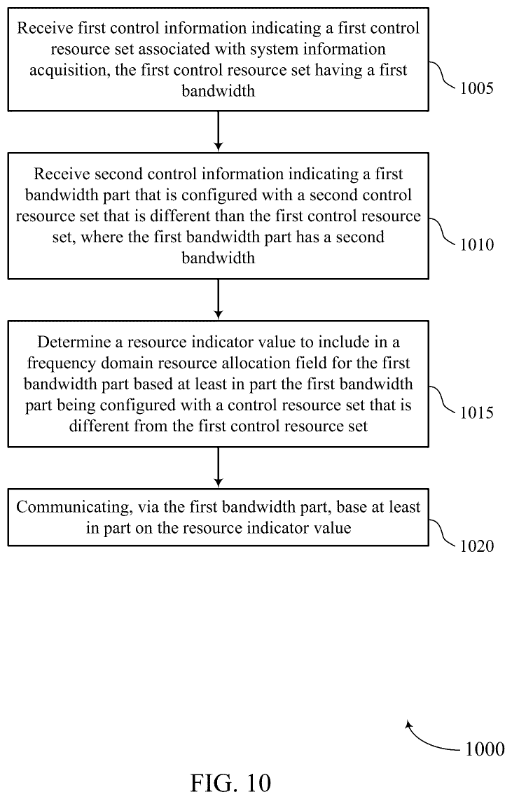

FIG. 10 shows a flowchart illustrating a method 1000 that supports resource allocation indication in unrestricted BWP in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving first control information indicating a first CORESET associated with SI acquisition, the first CORESET having a first bandwidth. The operations of block 1005 may be performed in accordance with examples as disclosed herein. In some examples, aspects of the operations of 1005 may be performed by a CORESET component 825 as described with reference to FIG. 8.

At 1010, the method may include receiving second control information indicating a first BWP that is configured with a second CORESET that is different than the first CORESET, where the first BWP has a second bandwidth. The operations of block 1010 may be performed in accordance with examples as disclosed herein. In some examples, aspects of the operations of 1010 may be performed by a BWP component 830 as described with reference to FIG. 8.

At 1015, the method may include determining a RIV to include in a FDRA field for the first BWP based at least in part on the first BWP being configured with a CORESET that is different from the first CORESET. The operations of block 1015 may be performed in accordance with examples as disclosed herein. In some examples, aspects of the operations of 1015 may be performed by a RIV component 835 as described with reference to FIG. 8.

At 1020, the method may include communicating, via the first BWP, based on the RIV. The operations of block 1020 may be performed in accordance with examples as disclosed herein. In some examples, aspects of the operations of 1020 may be performed by a communication component 840 as described with reference to FIG. 8.

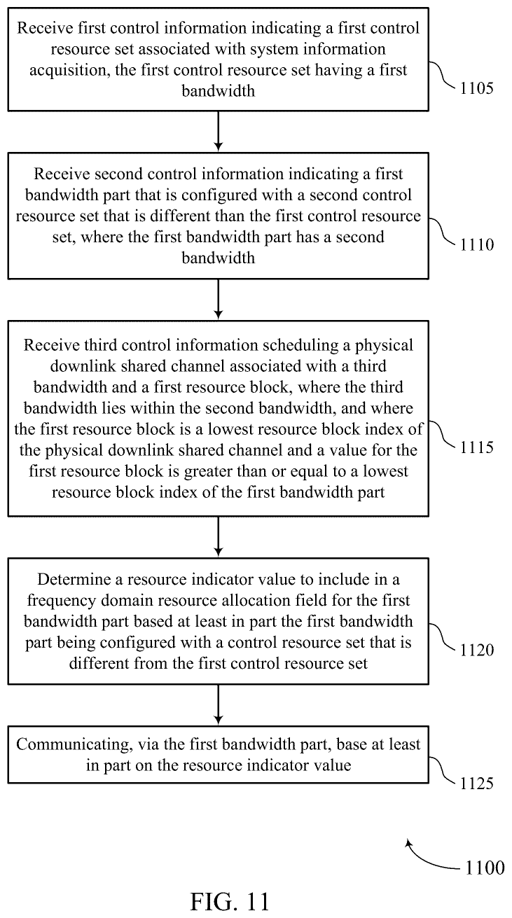

FIG. 11 shows a flowchart illustrating a method 1100 that supports resource allocation indication in unrestricted BWP in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving first control information indicating a first CORESET associated with SI acquisition, the first CORESET having a first bandwidth. The operations of block 1105 may be performed in accordance with examples as disclosed herein. In some examples, aspects of the operations of 1105 may be performed by a CORESET component 825 as described with reference to FIG. 8.

At 1110, the method may include receiving second control information indicating a first BWP that is configured with a second CORESET that is different than the first CORESET, where the first BWP has a second bandwidth. The operations of block 1110 may be performed in accordance with examples as disclosed herein. In some examples, aspects of the operations of 1110 may be performed by a BWP component 830 as described with reference to FIG. 8.

At 1115, the method may include receiving third control information scheduling a physical downlink shared channel associated with a third bandwidth and a first RB, where the third bandwidth lies within the second bandwidth, and where the first RB is a lowest RB index of the physical downlink shared channel and a value for the first RB is greater than or equal to a lowest RB index of the first BWP. The operations of block 1115 may be performed in accordance with examples as disclosed herein. In some examples, aspects of the operations of 1115 may be performed by a physical downlink shared channel component 845 as described with reference to FIG. 8.

At 1120, the method may include determining a RIV to include in a FDRA field for the first BWP based at least in part on the first BWP being configured with a CORESET that is different from the first CORESET. The operations of block 1120 may be performed in accordance with examples as disclosed herein. In some examples, aspects of the operations of 1120 may be performed by a RIV component 835 as described with reference to FIG. 8.

At 1125, the method may include communicating, via the first BWP, based on the RIV. The operations of block 1125 may be performed in accordance with examples as disclosed herein. In some examples, aspects of the operations of 1125 may be performed by a communication component 840 as described with reference to FIG. 8.

The following provides an overview of aspects of the present disclosure:
Aspect 1: A method for wireless communication, at a UE, comprising: receiving first control information indicating a first CORESET associated with system information acquisition, the first CORESET having a first bandwidth; receiving second control information indicating a first BWP that is configured with a second CORESET that is different than the first CORESET, wherein the first BWP has a second bandwidth; determining a resource indicator value to include in a frequency domain resource allocation field for the first BWP based at least in part on the first BWP being configured with a CORESET that is different from the first CORESET; and communicating, via the first BWP, based at least in part on the resource indicator value.
Aspect 2: The method of aspect 1, further comprising: receiving third control information scheduling a physical downlink shared channel associated with a third bandwidth and a first resource block, wherein the third bandwidth lies within the second bandwidth, and wherein the first resource block is a lowest resource block index of the physical downlink shared channel and a value for the first resource block is greater than or equal to a lowest resource block index of the first BWP.
Aspect 3: The method of aspect 2, wherein the first bandwidth is larger than the second bandwidth.
Aspect 4: The method of aspect 3, wherein determining the resource indicator value further comprises: determining a virtual bandwidth and the third bandwidth of the physical downlink shared channel, wherein the virtual bandwidth is equal to the first bandwidth, and a highest resource block index of the physical downlink shared channel is equal to or less than a minimum of a highest resource block index of the first BWP or a difference between the virtual bandwidth and the value for the first resource block, wherein the resource indicator value is determined using the virtual bandwidth, the value of the first resource block, and the third bandwidth.
Aspect 5: The method of aspect 3, wherein determining the resource indicator value further comprises: determining a virtual bandwidth and the third bandwidth of the physical downlink shared channel, wherein the virtual bandwidth is equal to the second bandwidth, and a highest resource block index of the physical downlink shared channel is equal to or less than a difference between the virtual bandwidth and the value for the first resource block, and wherein the resource indicator value is determined using the virtual bandwidth, the value of the first resource block, and the third bandwidth.
Aspect 6: The method of aspect 5, wherein determining the resource indicator value further comprises: calculating a first bit width based at least in part on a number of resource blocks of the first CORESET, wherein a second bit width is a bit width of the resource indicator value; and including the resource indicator value in the frequency domain resource allocation field if the second bit width is equal to the first bit width, or including the resource indicator value and a padding of bits in the frequency domain resource allocation field if the second bit width is less than the first bit width, wherein the padding of bits is equal to a difference between the first bit width and the second bit width.
Aspect 7: The method of aspect 2, wherein the second bandwidth is larger than the first bandwidth.
Aspect 8: The method of aspect 7, wherein determining the resource indicator value further comprises: determining a virtual bandwidth and the third bandwidth of the physical downlink shared channel, wherein the virtual bandwidth is equal to the first bandwidth, and a highest resource block index of the physical downlink shared channel is equal to or less than a difference between the virtual bandwidth and the value for the first resource block, and wherein the resource indicator value is determined using the virtual bandwidth, the value of the first resource block, and the third bandwidth.
Aspect 9: The method of aspect 7, wherein determining the resource indicator value further comprises: determining a virtual bandwidth and the third bandwidth of the physical downlink shared channel, wherein the virtual bandwidth is equal to the second bandwidth, and a highest resource block index of the physical downlink shared channel is equal to or less than a difference between the virtual bandwidth and the value for the first resource block, and wherein the resource indicator value is determined using the virtual bandwidth, the value of the first resource block, and the third bandwidth.
Aspect 10: The method of aspect 9, wherein determining the resource indicator value further comprises: calculating a first bit width based at least in part on the first CORESET, wherein a second bit width is a bit width of the resource indicator value; and including the resource indicator value in the frequency domain resource allocation field if the second bit width is equal to the first bit width, or including the resource indicator value and a truncated resource indicator value in the frequency domain resource allocation field if the second bit width is greater than the first bit width, wherein the truncated resource indicator value is equal to a difference between the second bit width and the first bit width.
Aspect 11: The method of aspect 2, wherein determining the resource indicator value further comprises: determining a virtual bandwidth and the third bandwidth of the physical downlink shared channel, wherein the virtual bandwidth is equal to the second bandwidth, and a highest resource block index of the physical downlink shared channel is equal to or less than a difference between the virtual bandwidth and the value for the first resource block, and wherein the resource indicator value is determined using the virtual bandwidth, a size of the first BWP, the value of the first resource block, and the third bandwidth.
Aspect 12: The method of aspects 2 and 7, wherein determining the resource indicator value further comprises: determining a size of a resource block group based at least in part on the second bandwidth and a baseline bandwidth, wherein the baseline bandwidth is equal to the first bandwidth or a fourth bandwidth associated with a second BWP, and wherein the resource indicator value is determined using at least the size of the resource block group.
Aspect 13: The method of any of aspects 1 through 12, wherein the first CORESET has a CORESET identification of zero.
Aspect 14: The method of aspect 13, wherein receiving the second control information indicating the first BWP further comprises: receiving the second control information over a radio resource control message or a system information message, wherein the first BWP is an unrestricted downlink BWP that is not associated with the first CORESET.
Aspect 15: The method of aspect 14, wherein the unrestricted downlink BWP is a dedicated downlink BWP configured by the radio resource control message for an eMBB UE in radio resource control connected state.
Aspect 16: The method of any of aspects 14 through 15, wherein the unrestricted downlink BWP is a dedicated downlink BWP configured by the radio resource control message for a RedCap or eRedCap UE in a connected state.
Aspect 17: The method of any of aspects 14 through 16, wherein the unrestricted downlink BWP is an initial downlink BWP configured by the system information message for random access by a RedCap or eRedCap UE in an idle or inactive state.
Aspect 18: The method of any of aspects 1 through 17, wherein a lowest resource block index of the first BWP is greater than or equal to a resource block index of the first CORESET.
Aspect 19: A UE for wireless communication, comprising one or more memories storing processor-executable code, and one or more processors coupled with the one or more memories and individually or collectively operable to execute the code to cause the UE to perform a method of any of aspects 1 through 18.
Aspect 20: A UE for wireless communication, comprising at least one means for performing a method of any of aspects 1 through 18.
Aspect 21: A non-transitory computer-readable medium storing code for wireless communication, the code comprising instructions executable by a processor to perform a method of any of aspects 1 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control information indicating a first control resource set associated with system information acquisition, the first control resource set having a first bandwidth;
receive second control information indicating a first bandwidth part that is configured with a second control resource set that is different than the first control resource set, wherein the first bandwidth part has a second bandwidth;
determine a resource indicator value to include in a frequency domain resource allocation field for the first bandwidth part based at least in part on the first bandwidth part being configured with a control resource set that is different from the first control resource set; and
communicate, via the first bandwidth part, based at least in part on the resource indicator value.

2. The UE of claim 1, wherein the first control resource set has a control resource set identification of zero.

3. The UE of claim 2, wherein, to receive the second control information indicating the first bandwidth part, the one or more processors are individually or collectively further operable to execute the code to cause the UE to:
receive the second control information over a radio resource control message or a system information message, wherein the first bandwidth part is an unrestricted downlink bandwidth part that is not associated with the first control resource set.

4. The UE of claim 3, wherein the unrestricted downlink bandwidth part is a dedicated downlink bandwidth part configured by the radio resource control message for an enhanced mobile broadband (eMBB) UE in radio resource control connected state.

5. The UE of claim 3, wherein the unrestricted downlink bandwidth part is a dedicated downlink bandwidth part configured by the radio resource control message for a reduced capability (RedCap) or enhanced RedCap (eRedCap) UE in a connected state.

6. The UE of claim 3, wherein the unrestricted downlink bandwidth part is an initial downlink bandwidth part configured by the system information message for random access by a reduced capability (RedCap) or enhanced RedCap (eRedCap) UE in an idle or inactive state.

7. The UE of claim 1, wherein the one or more processors are individually or collectively further operable to execute the code to cause the UE to:
receive third control information scheduling a physical downlink shared channel associated with a third bandwidth and a first resource block, wherein the third bandwidth lies within the second bandwidth, and wherein the first resource block is a lowest resource block index of the physical downlink shared channel and a value for the first resource block is greater than or equal to a lowest resource block index of the first bandwidth part.

8. The UE of claim 7, wherein, to determine the resource indicator value, the one or more processors are individually or collectively further operable to execute the code to cause the UE to:
determine a size of a resource block group based at least in part on the second bandwidth and a baseline bandwidth, wherein the baseline bandwidth is equal to the first bandwidth or a fourth bandwidth associated with a second bandwidth part, and wherein the resource indicator value is determined using at least the size of the resource block group.

9. The UE of claim 7, wherein, to determine the resource indicator value, the one or more processors are individually or collectively further operable to execute the code to cause the UE to:
determine a virtual bandwidth and the third bandwidth of the physical downlink shared channel, wherein the virtual bandwidth is equal to the second bandwidth, and a highest resource block index of the physical downlink shared channel is equal to or less than a difference between the virtual bandwidth and the value for the first resource block, and wherein the resource indicator value is determined using the virtual bandwidth, a size of the first bandwidth part, the value of the first resource block, and the third bandwidth.

10. The UE of claim 7, wherein the first bandwidth is larger than the second bandwidth.

11. The UE of claim 10, wherein, to determine the resource indicator value, the one or more processors are individually or collectively further operable to execute the code to cause the UE to:
determine a virtual bandwidth and the third bandwidth of the physical downlink shared channel, wherein the virtual bandwidth is equal to the first bandwidth, and a highest resource block index of the physical downlink shared channel is equal to or less than a minimum of a highest resource block index of the first bandwidth part or a difference between the virtual bandwidth and the value for the first resource block, wherein the resource indicator value is determined using the virtual bandwidth, the value of the first resource block, and the third bandwidth.

12. The UE of claim 10, wherein, to determine the resource indicator value, the one or more processors are individually or collectively further operable to execute the code to cause the UE to:
determine a virtual bandwidth and the third bandwidth of the physical downlink shared channel, wherein the virtual bandwidth is equal to the second bandwidth, and a highest resource block index of the physical downlink shared channel is equal to or less than a difference between the virtual bandwidth and the value for the first resource block, and wherein the resource indicator value is determined using the virtual bandwidth, the value of the first resource block, and the third bandwidth.

13. The UE of claim 12, wherein, to determine the resource indicator value, the one or more processors are individually or collectively further operable to execute the code to cause the UE to:
calculate a first bit width based at least in part on a number of resource blocks of the first control resource set, wherein a second bit width is a bit width of the resource indicator value; and
include the resource indicator value in the frequency domain resource allocation field if the second bit width is equal to the first bit width, or including the resource indicator value and a padding of bits in the frequency domain resource allocation field if the second bit width is less than the first bit width, wherein the padding of bits is equal to a difference between the first bit width and the second bit width.

14. The UE of claim 7, wherein the second bandwidth is larger than the first bandwidth.

15. The UE of claim 14, wherein, to determine the resource indicator value, the one or more processors are individually or collectively further operable to execute the code to cause the UE to:
determine a virtual bandwidth and the third bandwidth of the physical downlink shared channel, wherein the virtual bandwidth is equal to the first bandwidth, and a highest resource block index of the physical downlink shared channel is equal to or less than a difference between the virtual bandwidth and the value for the first resource block, and wherein the resource indicator value is determined using the virtual bandwidth, the value of the first resource block, and the third bandwidth.

16. The UE of claim 14, wherein, to determine the resource indicator value, the one or more processors are individually or collectively further operable to execute the code to cause the UE to:
determine a virtual bandwidth and the third bandwidth of the physical downlink shared channel, wherein the virtual bandwidth is equal to the second bandwidth, and a highest resource block index of the physical downlink shared channel is equal to or less than a difference between the virtual bandwidth and the value for the first resource block, and wherein the resource indicator value is determined using the virtual bandwidth, the value of the first resource block, and the third bandwidth.

17. The UE of claim 16, wherein, to determine the resource indicator value, the one or more processors are individually or collectively further operable to execute the code to cause the UE to:
calculate a first bit width based at least in part on the first control resource set, wherein a second bit width is a bit width of the resource indicator value; and
include the resource indicator value in the frequency domain resource allocation field if the second bit width is equal to the first bit width, or including the resource indicator value and a truncated resource indicator value in the frequency domain resource allocation field if the second bit width is greater than the first bit width, wherein the truncated resource indicator value is equal to a difference between the second bit width and the first bit width.

18. The UE of claim 1, wherein a lowest resource block index of the first bandwidth part is greater than or equal to a resource block index of the first control resource set.

19. A method for wireless communication, at a user equipment (UE), comprising:
receiving first control information indicating a first control resource set associated with system information acquisition, the first control resource set having a first bandwidth;
receiving second control information indicating a first bandwidth part that is configured with a second control resource set that is different than the first control resource set, wherein the first bandwidth part has a second bandwidth;
determining a resource indicator value to include in a frequency domain resource allocation field for the first bandwidth part based at least in part on the first bandwidth part being configured with a control resource set that is different from the first control resource set; and
communicating, via the first bandwidth part, based at least in part on the resource indicator value.

20. A user equipment (UE) for wireless communication, comprising:
means for receiving first control information indicating a first control resource set associated with system information acquisition, the first control resource set having a first bandwidth;
means for receiving second control information indicating a first bandwidth part that is configured with a second control resource set that is different than the first control resource set, wherein the first bandwidth part has a second bandwidth;
means for determining a resource indicator value to include in a frequency domain resource allocation field for the first bandwidth part based at least in part on the first bandwidth part being configured with a control resource set that is different from the first control resource set; and
means for communicating, via the first bandwidth part, based at least in part on the resource indicator value.
